(19) United States
(12) Patent Application Publication
(10) Pub. No.: US 2002/0138463 A1
(43) Pub. Date: Sep. 26, 2002

(54) Using dynamically encoded values to reduce storage requirements for low cardinality fields in a database

(75) Inventor: Allen Webster Heath, Westlake, TX (US)

Correspondence Address: J. Bruce Schelkopf, IBM Corp. PPSG Legal Dept., Dept., 9CCA/Bldg. 002-2, P.O. Box 12195, Research Triangle Park, NC, 27709, US

(73) Assignee: International Business Machines Corporation, Armonk, NY (US)

(21) Appl. No.: 09/814,990

(22) Filed: Mar. 22, 2001

(51) Int. Cl. G06F 7/00

(52) U.S. Cl. 707/1

(57) ABSTRACT

A method for reducing storage requirements in a database having at least one low cardinality field. Dynamically assigned encoded values are stored with associated string values of low cardinality in a permanent database table. The contents of the permanent database are loaded into a cache which is searched when entering new string values or retrieving existing string values. The encoded values are stored in the database records instead of the string value. When a string value is to be stored in a database, its code is looked up in the cache. If the string value is not found, the next encoded value is dynamically assigned and stored in the permanent database table of encoded values. The cache is reloaded with encoded value and string value pairs from the permanent database table. To retrieve the string value for a low cardinality field in a database record, the cache is searched for the encoded value to determine the associated string value. The string value is then returned to the end user.

### BACKGROUND OF THE INVENTION

The present invention relates generally to data processing systems, and more particularly, to methods for reducing storage requirements for low cardinality fields in a database.

Frequently, the information stored in a database column has low cardinality (i.e., a small set of values), but the information itself is lengthy. In a large database, this can result in much wasted storage.

### SUMMARY OF THE INVENTION

This invention describes a method to reduce the wasted storage space associated with storing information having low cardinality fields in a database. The field can be a specific column in a row of a database. This invention uses dynamically assigned coded values to represent the longer strings. The coded values are assigned at run time as needed, thus an application using this middleware invention does not have to be changed to take advantage of this invention. The bytes required to store the coded value into each record are much less than the bytes needed to store the original string.

### DESCRIPTION OF DRAWINGS

The present invention is better understood by reading the following detailed description of the invention in conjunction with the accompanying drawings, wherein:

FIG. 1 illustrates the processing logic for storing an encoded value associated with a string value of low cardinality in a database record in accordance with an exemplary embodiment of the present invention.

FIG. 2 illustrates the processing logic for retrieval of string values associated with encoded values in a database record in accordance with an exemplary embodiment of the present invention.

### DETAILED DESCRIPTION OF INVENTION

The invention solves the problem associated with storing low cardinality fields by acting to translate the information being stored and retrieved from the database. The application does not need to be recompiled, nor does it need to be made aware of the translation being done on its behalf. When a string value is to be stored in a column of a row in the database, its code is looked up in a cache of encoded values. If there is no encoded value for this string in the cache, the following steps are performed:

a. assign the next encoded value and store the encoded value in the permanent database table of encoded values;

b. handle contention by unique constraints on the database key (the coded value) and the coded value/original string value pair; thus if multiple processes are attempting to assign the same encoded value, the database agent will allow only one “insert” statement to be executed. This presents duplicates and the algorithm tries repeatedly until the uniqueness constraint is met;

c. reload the cache with the values from the permanent database table.

The encoded value as found above is then used and stored in the application's database record.

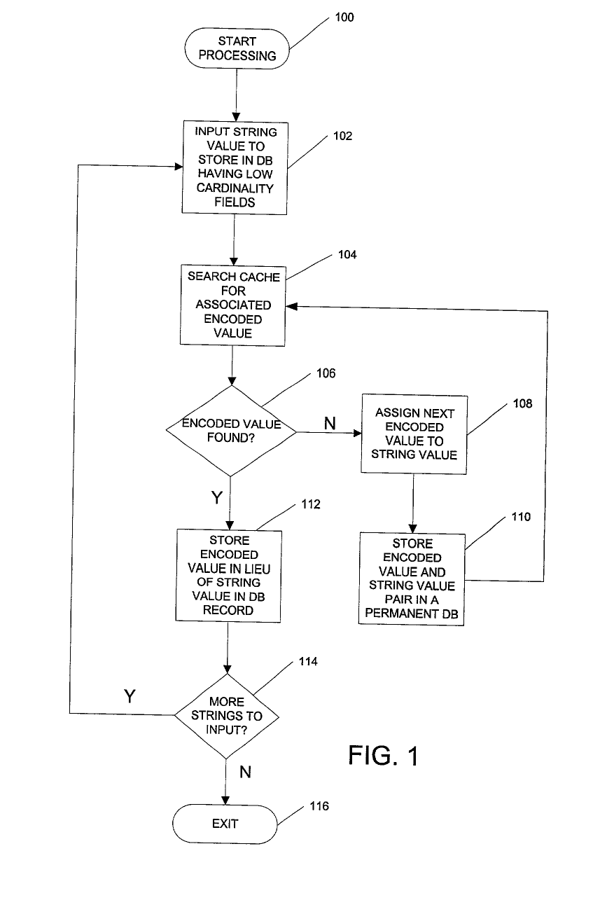

FIG. 1 illustrates the processing logic for storing an encoded value associated with a long string value of low cardinality in a database record. In general terms, the input comprises fields that are mapped into database columns, and database columns are extracted to build application fields. For example, an address field can be parsed into individual columns for city, state, and zip code. As indicated, processing begins with start block 100. In logic block 102, a string value is input that is to be stored in a database having at least one column of low cardinality. A cache is searched for an associated encoded value as indicated in logic block 104. A test is then made in decision block 106 to determine if the encoded value was found in the cache. If it was not, then as indicated in logic block 108, the next encoded value is assigned dynamically to the string. The encoded value and string value pair are then saved in a permanent database table, as indicated in logic block 110, and the cache is updated. The cache is then searched again as indicated by the return loop to logic block 104. This time the encoded value is found in decision block 106. If an encoded value was found in the cache in decision block 106, processing continues in logic block 112 with storing of the encoded value in lieu of the string value in the record in the database. In decision block 114, a test is made to determine if there are more string values to input. If there are, then processing returns to logic block 102 for the input of the next string. Otherwise, processing exits in termination block 116.

When a string value is to be retrieved from a row of a database, if the cache does not contain this encoded value, then the cache is reloaded. Thus, to fetch a record that was just encoded by another process, reloading the cache will get the newly assigned coded value pairing. The associated string for the encoded value is substituted into the result set being returned to the application.

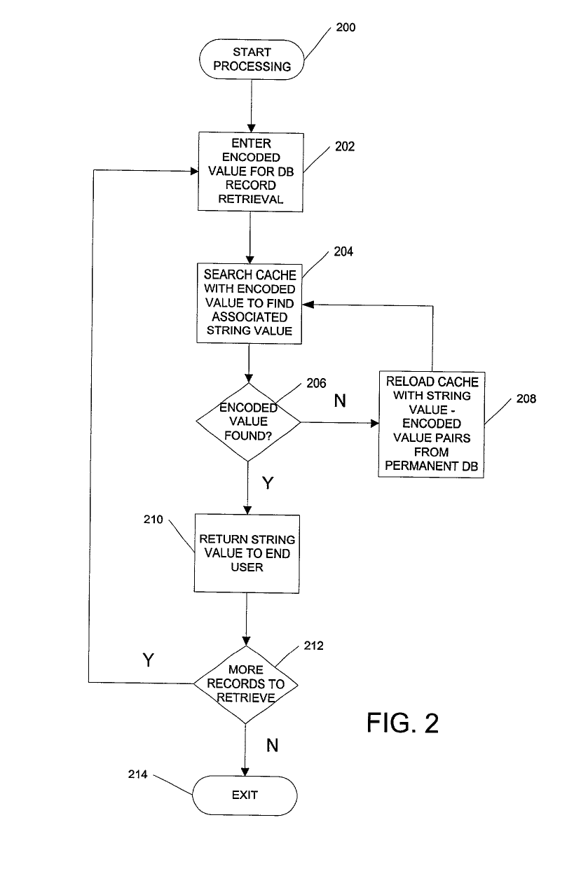

FIG. 2 illustrates the processing logic for retrieval of string values associated with encoded values in a database record. The process for retrieving records starts with logic block 200. The encoded value for database record retrieval is entered by the system access method as indicated in logic block 202. The cache is searched with the encoded value to find an associated string value, as indicated in logic block 204. A test is made in decision block 206 to determine if the encoded value is found. If not, then the cache is reloaded with string value—encoded value pairs from a permanent database table, as indicated in logic block 208. After the cache is reloaded in logic block 208, processing loops back to logic block 204 where the reloaded cache is searched for the encoded value. If the encoded value is found in the cache in decision block 206, the encoded value is decoded, and processing continues in logic block 210, with the return of the string value to the end user. In decision block 212, a test is made to determine if there are more records to retrieve. If yes, then processing returns to logic block 202 for entry of the next encoded value. Otherwise, processing exists as indicated in termination block 214.

Other applications have implemented coded values to minimize storage, however this invention uses dynamically assigned values. The prior art uses values that are preassigned, for example, a medical procedure code. This has the disadvantage in that the application must be “patched” or recompiled, or tables manually built, to add additional new procedure codes. For example, such a process is used in dealing with a health provider's network codes and ensuring multiple servers are using the same values.

As a simple application of the invention, consider a state vehicle registration database. The number (cardinality) of different makes of cars, e.g., Ford, Chevrolet, Toyota, Mercedes Benz, etc. is relatively low, and can be stored using an integer that can map up to 65,536 different names. Thus, implementation of the present invention can easily shrink the requirement for this field (i.e., column) down to 2 bytes from a size of 18- 25 bytes or greater. Even if the database designer did not use a simple CHAR (for the fixed worst case size) an instead used a VARCAR (which is a variable length character string) of which typically two bytes are used to indicated the length of the string that follows. Implementation of this invention requires only 2 bytes to describe the name. Therefore, even a short name such as Ford can require 6 or 7 bytes without the use of this invention, while the longer car names will require even more.

To register a car, a data entry person inputs the manufacturer's name, such as “Chevrolet”, through the front end operator interface. The middleware software uses this invention and typically finds the name, “Chevrolet”, already in the cache and assigns to it the existing code, e.g., 16. The process then uses the code 16 to store the registration information into a lower level motor vehicle database record, and propagates this information to other state and local agencies. Continuing with this example, assume that a law enforcement officer stops the new registrant for a driving infraction and runs a check on the license plate. The license plate number is a key into the lower level database which finds the new registration record and returns it to the middleware software wherein this invention is resident. The encoded value 16 from the database is looked up in the cache, which may not have the value yet, since it may have been the law enforcement officer's first stop of the day. The permanent database table is then queried, reloading the cache. The code 16 is now found to map to “Chevrolet”. This string is substituted for the code and passed from the middleware software to the requesting application and the officer sees the name “Chevrolet” as the make of the registered vehicle. Without this invention, this string “Chevrolet” would have been stored in the permanent database, and as there are many “Chevrolet” records, there is a substantial amount of redundant space in the database that is being used to track a few million vehicles.

Taking this example one step further shows why the prior art encoding methods do not solve the problem. Consider the case of a car owner who wants to register a rare antique “Tucker”. Since only fifty Tuckers were ever manufactured, there may not be any records in the database for the name of the manufacturer. Using the prior art methods, the clerk would get a programming error, since a “Tucker” is not in the code of values table. Using the invention, “Tucker” would not be found initially, so a new dynamic code would be assigned, e.g., 18237, as this particular office considers that value as the next one available. The invention attempts to store this value in the dynamic coded value permanent database. This database includes a “must be unique” constraint on the code key. Consider that in another part of the state, another person has just registered his “Cord” and “Bentley” vehicles, both of which were also unknown in the database. That other office may attempt to assign codes 18237 and 18238 to the additional car manufacturer names, which do not appear in the other office's local cache since there has been no need to refresh the cache until now. The invention makes use of this “must be unique” constraint in attempting to add a new code, e.g. 18237, in the permanent database. The constraint is violated, thereby requiring the local office to refresh its cache, find that number 18239 is available, and attempt to use that number. If at the same time, another office is handling another exception and succeeds in assigning code 18239 to “Amphicar”, the automatic process is then repeated and the software at the motor vehicle office tries 18240, which succeeds, and thus, the “Tucker” record is encoded with 18240 and is propagated to the local database(s).

As another embodiment, consider a health provider's network that uses a master person index (MP1) to manage “locator” records which inform the health provider's network where data is located in the network. In the following example, one of the candidate fields is the name of the server that is storing the information. In one implementation, this is a 20 character field that has a very low cardinality of values, usually less than 10 server names in a typical environment. The original 20 character field stores the Transmission Control Protocol/ Internet Protocol (TCP/IP) name of the server that holds the information being located. A two-byte integer can easily contain an encoded value that can be used as an index into a cached table of 20 character values. This invention assigns encoded values dynamically as needed, and supports a multiple processor environment. The same server name may be transparently encoded differently on other servers. With the dynamic addition feature, if a new server with a new TCP/IP name is added to a computing environment, the invention recognizes that it needs to dynamically assign another new unique code and thus the application does not have to be recompiled. The invention has the side benefit that if a server fails, or is upgraded and replaced by a server with a different name, the entire locator database does not have to updated to store a lengthy new string value, only the one value in a dynamic coded values table needs to be changed to reflect the new name.

In the example of a health provider network, there are several fields in the master person index (MPI) database than can use this technique to greatly reduce the amount of storage needed per record, thus allowing far more locator records to be stored in the same direct access storage device (DASD). The above-described savings considers the base locator table only. Several of the candidate fields are also involved in database (e.g., DB2) indexes, thus when those fields which also participate in an index are encoded, the storage required for the indexes will also be greatly reduced thereby further increasing the number of customer records that can be effectively stored. For example, in an actual environment containing 20 million locator rows, the storage savings could easily exceed 2.5 gigabytes when the indexes are also considered.

More specifically, consider a health data network environment with medical records stored on multiple servers. In a hospital/insurance network, a person's record can exist in the insurance database. The person can visit a clinic for lab work with the clinic's server storing certain information about the person. The person can also visit a hospital for laboratory tests, with the results stored on the hospital's server. The person's doctor may refer him to a specialist where additional medical information can be stored on yet another server. In the health data network environment, a Master Person Index (MPI) is used to locate all this information stored on various servers. There are numerous security and data ownership issues involved, so the MPI only records the fact that information about the person exists, where to find, and what type it is, e.g., lab reports, charts, insurance eligibility, demographics, etc. Thus, part of the information that the MPI needs to track is the server name on which the information resides.

The TCP/IP protocol is the networking protocol in most common use today. Server names are related to the host IP names/addresses. Any other transport and network layer addressing scheme can also be used with this invention. Assume the information that the MPI needs to know for the person is on “server3.tbcbs.com” (e.g., Texas Blue Cross and Blue Shield) and some other information is on server “main.dfw.doctors.net”. There can be millions of subscriber records located at Blue Cross and Blue Shield, and if each of the “locators” for those records had to store the string of “server3.tbcbs.com” with each record, large amounts of storage would be consumed. In addition, some server names can be very lengthy. For example, a server name such as, “clinic 6.coloradodoctorsguild.coloradosprings.co.us”, can greatly increase the space requirements to store this type of information. However, even a large network is typically going to have information stored on a relatively few servers (possibly hundreds of servers) compared to storing millions of subscriber records. By implementing this invention and encoding the server address names that must be associated with each record, the reduction in storage requirements can be very significant. Considering the dynamics of the medical profession, doctors groups are constantly being added or changed. By being able to dynamically assign these coded values to the server names, when a new server such as “server.peopleschoice.net” joins the health data network with a group of doctors, all the other servers can easily adapt to the change. Consider the situation of an insurer that grows so large that the subscriber data must be moved to a new larger mainframe, while retaining the older server machine online to perform other work. This would require the addition of a new server name to the environment and moving of subscriber data to the more capable server. It is far easier to update the one encode/decode database record and void the network's cache to reflect the new server name/address than to process millions of records to change an embedded “server 3.tbcbs.com” to “deepblue.tbcbs.com”.

The present invention is realized in software. Any kind of computer system or other apparatus adapted for carrying out the methods described herein is suited. A typical combination of hardware and software could be a general purpose computer system with a computer program that, when loaded and executed, controls the computer system such that it carries out the methods described herein. The present invention can also be embedded in a computer program product, which includes all of the features enabling the implementation of the methods described herein and which, when loaded in a computer system, is able to carry out these methods.

Computer program instructions or computer program in the present context means any expression in any language, code or notation, or a set of instructions intended to cause a system having an information processing capability to perform a particular function, either directly or when either or both of the following occur: (a) conversion to another language, code or notation; (b) reproduction in a different material form.

Those skilled in the art will appreciate that many modifications to the preferred embodiment of the present invention are possible without departing from the spirit and scope of the present invention. In addition, it is possible to use some of the features of the present invention without the corresponding use of the other features. Accordingly, the foregoing description of the preferred embodiment is provided for the purpose of illustrating the principles of the present invention and not in limitation thereof since the scope of the present invention is defined solely by the appended claims.

What is claimed is:

1. A method for reducing storage requirements in a database having low cardinality fields, comprising the steps of:
reading a string value to store in a low cardinality field in a database record;
searching a cache for the string value to determine an associated encoded value; and
storing the encoded value in the database record.

2. The method for reducing storage requirements in a database of claim 1 further comprising the steps of:
assigning an encoded value dynamically to the string value if there is no entry found for the string value in the cache; and
storing the encoded value and string value pair in a permanent database table of encoded values.

3. The method for reducing storage requirements in a database of claim 2 further comprising the step of resolving contention between multiple processes attempting to assign a same encoded value to a string value by allowing only one of the multiple processes to assign the encoded value.

4. The method for reducing storage requirements in a database of claim 2 further comprising reloading the cache with encoded value and string value pairs.

5. A method for retrieval of a string value stored in encoded form in a database having low cardinality fields, comprising the steps of:
reading an encoded value as a database key to retrieve a database record;
searching a cache for the encoded value to determine the associated string value; and
returning the string value to the end user.

6. The method for retrieval of a string value stored in encoded form in a database of claim 5 further comprising the step of reloading the cache with encoded value and string value pairs stored in a permanent database table.

7. A computer readable medium containing a computer program product for reducing storage requirements in a database having low cardinality fields, the computer program product comprising:
program instructions that read a string value to store in a low cardinality field in a database record;
program instructions that search a cache for the string value to determine an associated encoded value;
program instructions that store the encoded value in the database record.

8. The computer program product for reducing storage requirements in a database of claim 7 further comprising:
program instructions that assign an encoded value dynamically to the string value if there is no entry found for the string value in the cache; and
program instructions that store the encoded value and string value pair in a permanent database table of encoded values.

9. The computer program product for reducing storage requirements in a database of claim 7 further comprising program instructions that resolve contention between multiple processes attempting to assign a same encoded value to a string value by allowing only one of the multiple processes to assign the encoded value.

10. The computer program product for reducing storage requirements in a database of claim 7 further comprising program instructions that reload the cache with encoded value and string value pairs.

11. A computer readable medium containing a computer program product for the retrieval of a string value stored in encoded form in a database having low cardinality fields, the computer program product comprising:
program instructions that read an encoded value as a database key to retrieve a database record;
program instructions that search a cache for the encoded value to determine the associated string value;
program instructions that return the string value in a display to the end user.

12. The computer program product for retrieval of a string value stored in encoded form of claim 11 further comprising program instructions that reload the cache with encoded value and string value pairs stored in a permanent database table.

13. A system for reducing storage requirements in a database having low cardinality, comprising:
at least one storage device for storing the database and a permanent database table; and
a computer processor connected to the at least one storage device and operating a computer program including:
an input component for reading a string value to store in a low cardinality field in a database record;
a search component for searching a cache for the string value to determine an associated encoded value; and
a storage component that stores the encoded value in the database record.

14. The system for reducing storage requirements in a database of claim 13 wherein the computer program further comprises:
a component for assigning an encoded value dynamically to the string value if there is no entry found for the string value in the cache; and
a storage component for storing the encoded value and string value pair in a permanent database table of encoded values.

15. The system for reducing storage requirements in a database of claim 13 further wherein the computer program further comprises a component for resolving contention between multiple processes attempting to assign a same encoded value to a string value by allowing only one of the multiple processes to assign the encoded value.

16. The system for reducing storage requirements in a database of claim 13 wherein the computer program further comprises a component for reloading the cache with encoded value and string value pairs.

17. A system for retrieval of a string value stored in encoded form in a database, comprising:
at least one storage device for storing the database and a permanent database table; and
a computer processor connected to the at least one storage device and operating a computer program including:
an input component for reading an encoded value as a database key to retrieve a database record;
a search component for searching a cache for the encoded value to determine the associated string value; and
a display component for returning the string value to the end user.

18. The system for retrieval of a string value stored in encoded form in a database of claim 17 wherein the computer program further comprises a component that reloads the cache with encoded value and string value pairs stored in the permanent database table.
